(19) United States
(12) Patent Application Publication
(10) Pub. No.: US 2010/0153158 A1
(43) Pub. Date: Jun. 17, 2010

(54) PROVIDING PROJECT MANAGEMENT SOFTWARE APPLICATION AS ENTERPRISE SERVICES

(75) Inventors: Norbert Wex, Walldorf (DE); Roland Kaschner, Heidelberg (DE); Dieter Krisch, Karlsruhe (DE); Michael Meyringer, Rauenberg (DE); Volker Faisst, Nussloch (DE); Otfried Von Geisau, Sinsheim (DE); Volker Schott, Nussloch (DE); Sabine Lamprecht, Walldorf (DE); Ingo Feucht, Walldorf (DE); Georg Vincent Heryschek, Mannheim (DE); Berthold Wocher, Gaiberg (DE); Andrea Sudbrack, Heidelberg (DE); Peer Marschall, Heidelberg (DE); Arno Mielke, Karlsruhe (DE); Andre Doerfler, Mannheim (DE); Peter Fitz, Waldsee (DE); Christoph Jungkind, Heidelberg (DE); Helgi Thorleifsson, Gaiberg (DE); Matthias Tebbe, Walldorf (DE); Ralf Dinkel, Wailbstadt-Daisbach (DE); Astrid Graeber, Walldorf (DE); Edwin Himmelsbach, Heidelberg (DE); Daniel Bock, Dossenheim (DE); Martin Osterloh, Leimen (DE); Silke Massmann, Heidelberg (DE); Klaus Herter, Leimen (DE); Ralph Moessner, Pfinztal (DE); Vsevolod Barabanov, Sandhausen (DE); Andreas Kasparek, Schwetzingen (DE); Jens Griessmann, Walldorf (DE); Vytas Cirpus, Waldsee (DE); Tanja Rueckel, Waghaeusel (DE)

Correspondence Address: FISH & RICHARDSON, P.C., PO BOX 1022, MINNEAPOLIS, MN, 55440-1022, US

(73) Assignee: SAP AG

(21) Appl. No.: 12/333,146

(22) Filed: Dec. 11, 2008

(51) Int. Cl. G06Q 10/00; G06Q 30/00; G06F 17/30

(52) U.S. Cl. 705/8; 705/34; 705/32; 705/9; 707/E17.044

(57) ABSTRACT

Methods and apparatus, including systems and computer program products, for a service architecture design that provides enterprise services having project management functionality at the level of an enterprise application. The design includes a set of service operations, process components, and optionally deployment units. Suitable business objects are also described.

### BACKGROUND

This specification relates to data processing systems implemented on computers, and, more particularly, to data processing systems providing services in the nature of web services.

Enterprise software systems are generally large and complex. Such systems can require many different components, distributed across many different hardware platforms, possibly in several different geographical locations. Thus, the architecture of a large software application, i.e., what its components are and how they fit together, is an important aspect of its design for a successful implementation.

Web services are one technology for making the functionality of software applications available to other software, including other applications. A web service is a standard-based way of encapsulating the functionality of an application that other applications can locate and access. A service-oriented architecture is a distributed software model within which all functionality is defined as independent web services. Within a service-oriented architecture, web services can be used in defined sequences according to the business logic to form applications that enable business processes.

### SUMMARY

This specification describes a services architecture design that provides enterprise services having project management functionality at the level of an enterprise application. Enterprise services are web services that have an enterprise-level business value.

In its various aspects, the invention can be embodied in systems, methods, and computer program products. For example, a system in one embodiment implements a services architecture design that provides enterprise services having project management functionality at the level of an enterprise application. The design may include a set of service operations, process components, and optionally deployment units. Suitable business objects are also described.

The subject matter described in this specification can be implemented to realize one or more of the following advantages. Effective use is made of process components as units of software reuse, to provide a design that can be implemented reliably in a cost effective way. Effective use is made of deployment units, each of which is deployable on a separate computer hardware platform independent of every other deployment unit, to provide a scalable design. Service interfaces of the process components define a pair-wise interaction between pairs of process components that are in different deployment units in a scalable way.

Details of one or more implementations of the subject matter described in this specification are set forth in the accompanying drawings and in the description below. Further features, aspects, and advantages of the subject matter will become apparent from the description, the drawings, and the claims.

### BRIEF DESCRIPTION OF THE DRAWINGS

FIGS. 1A and 1B collectively illustrate a high-level view of a software architectural design and implementation of a suite enterprise software services having project management functionality.

FIGS. 2A, 2B, 2C, 2D, and 2E are block diagrams collectively showing a project processing process component.

FIG. 3 is a block diagram showing a customer project invoice preparation process component.

FIG. 4 is a block diagram showing an engineering change processing process component.

FIG. 5 is a block diagram showing a product requirement specification processing process component.

### DETAILED DESCRIPTION

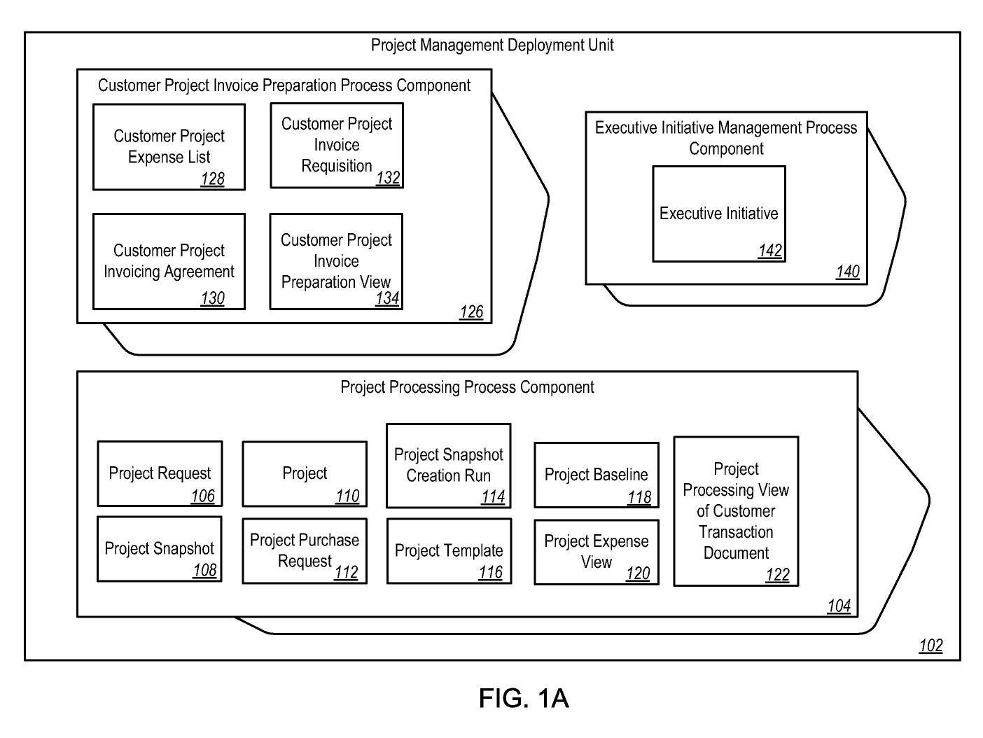

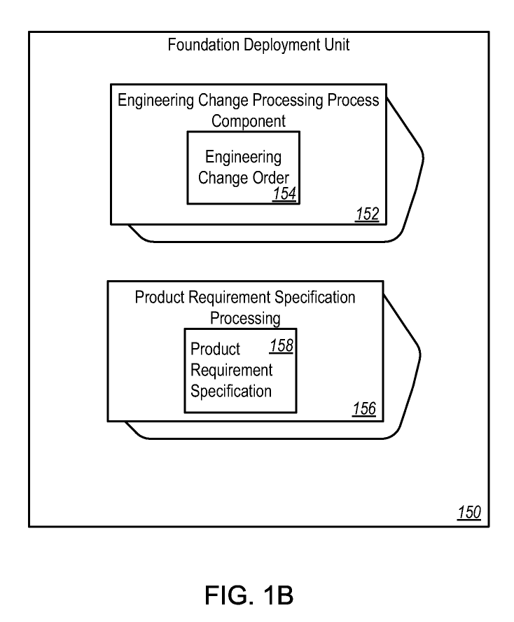

FIGS. 1A and 1B collectively illustrate a high-level view of a software architectural design and of an application software implementation that provides a suite of enterprise service operations, which can be organized into interfaces, having project management application functionality. The software corresponding to FIGS. 1A and 1B, in one implementation, is for deployment in an application layer of an application server.

The elements of the architecture include the business object, the process component, the service operation (or simply, the operation), the service interface, the message, and the deployment unit. The elements can also include process agents and reuse service components. These will be generally described below.

In some implementations, the software can be deployed on an application platform that includes a foundation layer that contains substantially all fundamental entities that can be used from multiple deployment units. These entities can be process components, business objects and/or reuse service components. A reuse service component may be a piece of software that is reused in different transactions. A reuse service component may be used by its defined interfaces, which can be, e.g., local APIs (Application Programming Interfaces) and/or service interfaces.

The architectural design may be a specification of a computer software application, and elements of the architectural design may be implemented to realize a software application that implements enterprise application service interfaces. The elements of the architecture are at times described in this specification as being contained or included in other elements; for example, a process component is described as being contained in a deployment unit. It should be understood, however, that such operational inclusion can be realized in a variety of ways and is not limited to a physical inclusion of the entirety of one element in another.

The architectural elements may include business objects. A business object may be a representation of a type of a uniquely identifiable business entity (an object instance) described by a structural model. Processes may operate on business objects.

A business object represents a specific view on some well-defined business content. A business object represents content, and instances of business objects include content, which a typical business user would expect and understand with little explanation. Whether an object as a type or an instance of an object is intended by the term is generally clear from the context, so the distinction will be made explicitly only when necessary. Properly implemented, business objects may be implemented free of redundancies.

Business objects may be further categorized as business process objects and master data objects. A business object may be an object that encapsulates master data (i.e., data that is valid for a period of time). A business process object, which is often the kind of business object generally found in a process component, may be an object that encapsulates transactional data, i.e., data that is valid for a point in time. A mass data run object may be an application object that executes an algorithm for a particular mass data run. An instance of a mass data run object may contain a particular set of selections and parameters. A mass data run object may implement an algorithm that modifies, manages, and/or processes a large amount of data in multiple transactions, possibly but not necessarily with parallel processing. A dependent object may be a business object used as a reuse part in another business object. A dependent object may represent a concept that cannot stand by itself from a business point of view. Instances of dependent objects can, in some implementations, only occur in the context of a non-dependent business object. A transformed object may be a transformation of multiple business objects for a well-defined purpose. It may transform the structure of multiple business objects into a common structure. In some implementations, the transformed object does not have its own persistency.

The architectural elements may also include the process component. A process component may include a software package that realizes a business process and generally exposes its functionality as services. The functionality may contain business transactions. A process component may contain one or more semantically related business objects. Any business object may belong to no more than one process component.

Process components may be modular and context-independent. That they are context-independent means that a process component may be not specific to any specific application and may be reusable. The process component may be the smallest (most granular) element of reuse in the architecture.

The architectural elements may also include the operation. An operation may belong to exactly one process component. A process component generally has multiple operations. Operations may be synchronous or asynchronous, corresponding to synchronous or asynchronous process agents, which will be described below. An operation may be the smallest, separately-callable function, described by a set of data types used as input, output, and fault parameters, or some combination of them serving as a signature. For convenience in supporting use of the operations supported by a system implementing elements of the design, such a system can optionally include a repository of service descriptions that includes a standards-based description of each of the supported service operations.

The architectural elements may also include the service interface, which may be referred to simply as an interface. An interface may be a named group of operations. Each operation may belong to exactly one interface. An interface may belong to exactly one process component. A process component might contain multiple interfaces. In some implementation, an interface can contain only inbound or outbound operations, but not a mixture of both. One interface may contain both synchronous and asynchronous operations. All operations of the same type (either inbound or outbound) which belong to the same message choreography may belong to the same interface. Thus, generally, all outbound operations to the same other process component may be in one interface.

The architectural elements may also include the message. Operations may transmit and receive messages. Any convenient messaging infrastructure may be used. A message may be information conveyed from one process component instance to another, with the expectation that activity will ensue. An operation may use multiple message types for inbound, outbound, and/or error messages. When two process components are in different deployment units, invocation of an operation of one process component by the other process component may be accomplished by an operation on the other process component sending a message to the first process component.

The architectural elements may also include the process agent. Process agents may do business processing that involves the sending or receiving of messages. Each operation frequently has at least one associated process agent. A process agent may be associated with one or more operations. Process agents may be either inbound or outbound, and either synchronous or asynchronous.

Asynchronous outbound process agents may be called after a business object changes, e.g., after a create, update, or delete of a business object instance.

Synchronous outbound process agents may be generally triggered directly by a business object.

An output process agent may generally perform some processing of the data of the business object instance whose change triggered the event. An outbound agent may trigger subsequent business process steps by sending messages using well-defined outbound services to another process component, which may be in another deployment unit, or to an external system. An outbound process agent may be linked to the one business object that triggers the agent, but it may be sent not to another business object but rather to another process component. Thus, the outbound process agent may be implemented without knowledge of the exact business object design of the recipient process component.

Inbound process agents may be called after a message has been received. Inbound process agents may be used for the inbound part of a message-based communication. An inbound process agent may start the execution of the business process step requested in a message by creating or updating one or multiple business object instances. An inbound process agent may not be the agent of a business object but of its process component. An inbound process agent may act on multiple business objects in a process component.

Synchronous agents may be used when a process component requires a more or less immediate response from another process component, and is waiting for that response to continue its work.

Operations and process components may be described in this specification in terms of process agents. However, in alternative implementations, process components and operations may be implemented without use of agents using other conventional techniques to perform the functions described in this specification.

The architectural elements may also include the deployment unit. A deployment unit may include one or more process components and, optionally, one or more business objects, that may be deployed together on a single computer system platform. Conversely, separate deployment units may be deployed on separate physical computing systems. For this reason, a deployment unit boundary may define the limits of an application-defined transaction, i.e., a set of actions that have the ACID properties of atomicity, consistency, isolation, and durability. To make use of database manager facilities, the architecture may require that all operations of such a transaction be performed on one physical database; as a consequence, the processes of such a transaction may be performed by the process components of one instance of one deployment unit.

The process components of one deployment unit may interact with those of another deployment unit using messages passed through one or more data communication networks or other suitable communication channels. Thus, a deployment unit deployed on a platform belonging one business may interact with a deployment unit software entity deployed on a separate platform belonging to a different and unrelated business, allowing for business-to-business communication. More than one instance of a given deployment unit may execute at the same time, on the same computing system or on separate physical computing systems. This arrangement may allow the functionality offered by a deployment unit to be scaled to meet demand by creating as many instances as needed.

Since interaction between deployment units may be through service operations, a deployment unit may be replaced by other another deployment unit as long as the new deployment unit supports the operations depended upon by other deployment units. Thus, while deployment units may depend on the external interfaces of process components in other deployment units, deployment units may not depend on process component interactions, i.e., interactions between process components involving their respective business objects, operations, interfaces, and messages within other deployment units. Similarly, process components that interact with other process components or external systems only through messages, e.g., as sent and received by operations, may also be replaced as long as the replacement supports the operations of the original.

Interactions between process components that occur only within a deployment unit may not constrained to using service operations. These may be implemented in any convenient fashion.

In contrast to a deployment unit, the foundation layer may not define a limit for application-defined transactions. Deployment units may communicate directly with entities in the foundation layer, which communication is typically not message based. The foundation layer may be active in every system instance on which the application is deployed. Business objects in the foundation layer may be master data objects. In addition, the foundation layer may include some business process objects that are used by multiple deployment units. Master data objects and business process objects that should be specific to a deployment unit may be assigned to their respective deployment unit.

FIGS. 1A and 1B collectively illustrate a high-level view of a software architectural design and implementation of a suite enterprise software services having project management functionality.

As shown in FIG. 1A, a project management deployment unit 102 includes a Project Processing process component 104, a Customer Project Invoice Preparation process component 126, and an Executive Initiative Management process component 140.

The Project Processing process component 104 includes a Project Request business object 106, a Project Snapshot business object 108, a Project business object 110, a Project Purchase Request business object 112, a Project Snapshot Creation Run business object 114, a Project Template business object 116, a Project Baseline business object 118, a Project Expense View business object 120, and a Project Processing View Of Customer Transaction Document business object 122.

The Customer Project Invoice Preparation process component 126 includes a Customer Project Expense List business object 128, a Customer Project Invoicing Agreement business object 130, a Customer Project Invoice Requisition business object 132, and a Customer Project Invoice Preparation View business object 134.

The Executive Initiative Management process component 140 includes an Executive Initiative business object 142.

As shown in FIG. 1B, the implementation includes a Foundation deployment unit 150. The Foundation deployment unit 150 includes an Engineering Change Processing process component 152 and a Product Requirement Specification Processing process component 156. The Engineering Change Processing process component 152 includes an Engineering Change Order business object 154. The Product Requirement Specification Processing process component 156 includes a Product Requirement Specification business object 158.

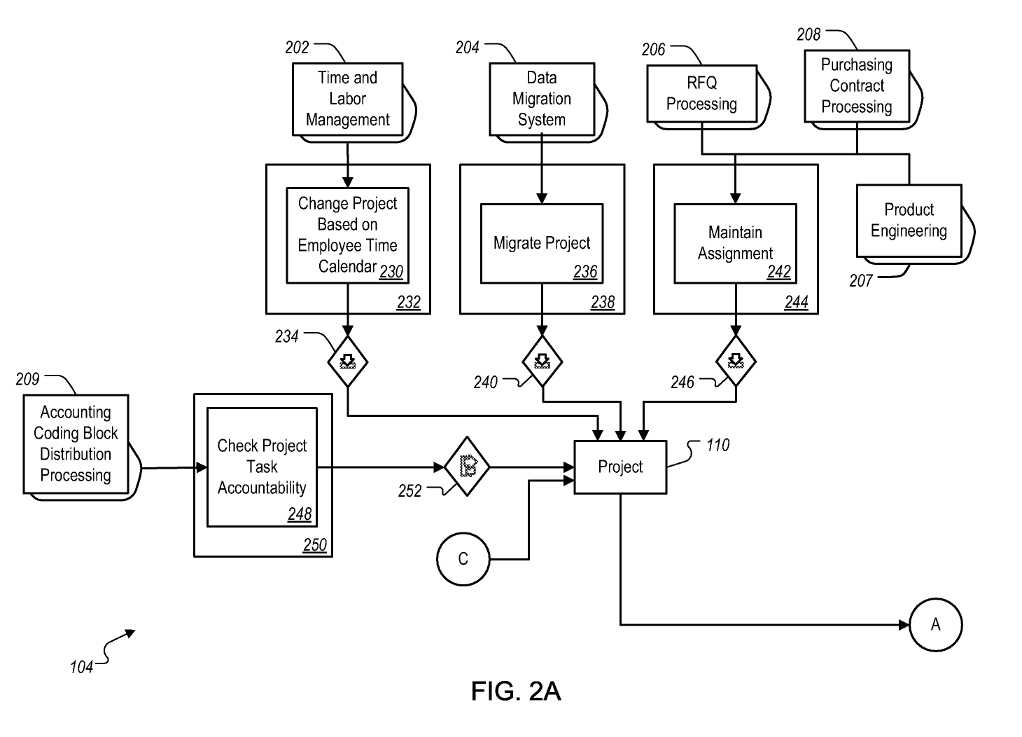

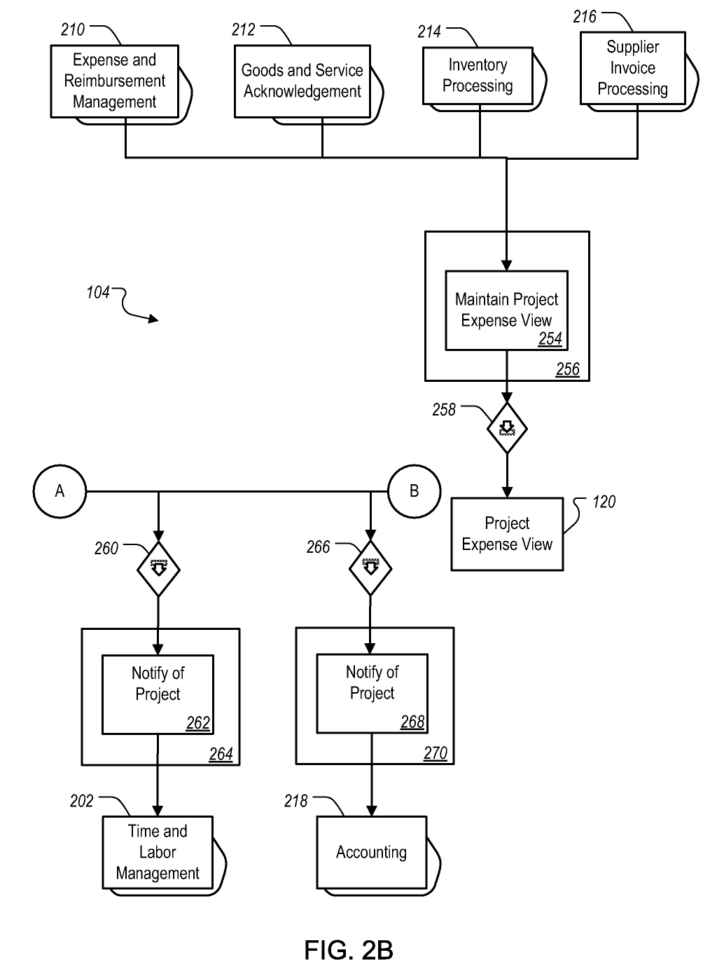

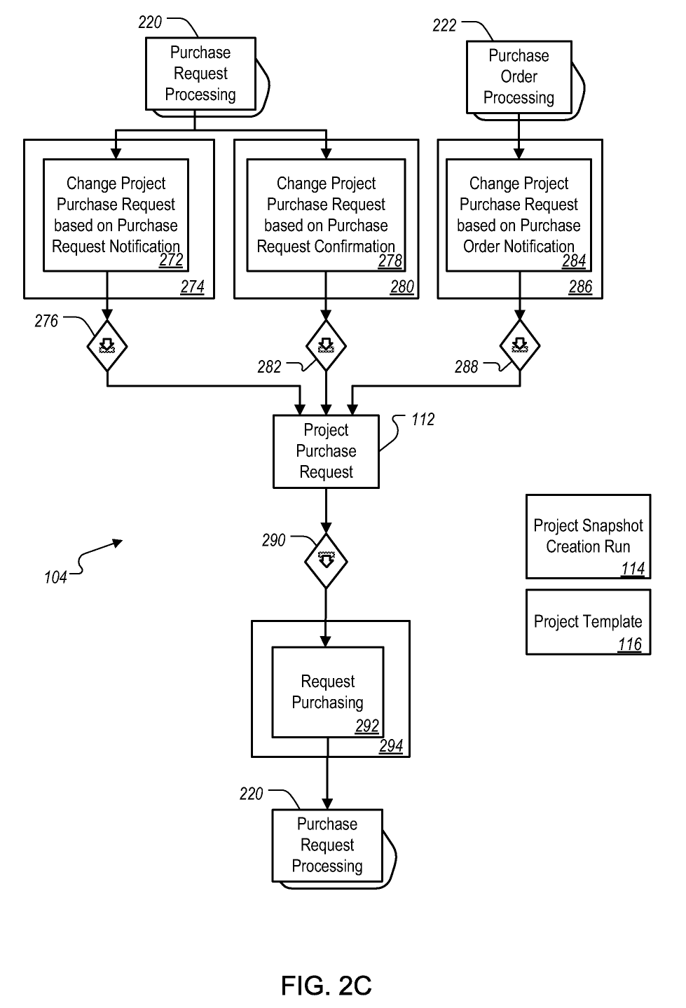

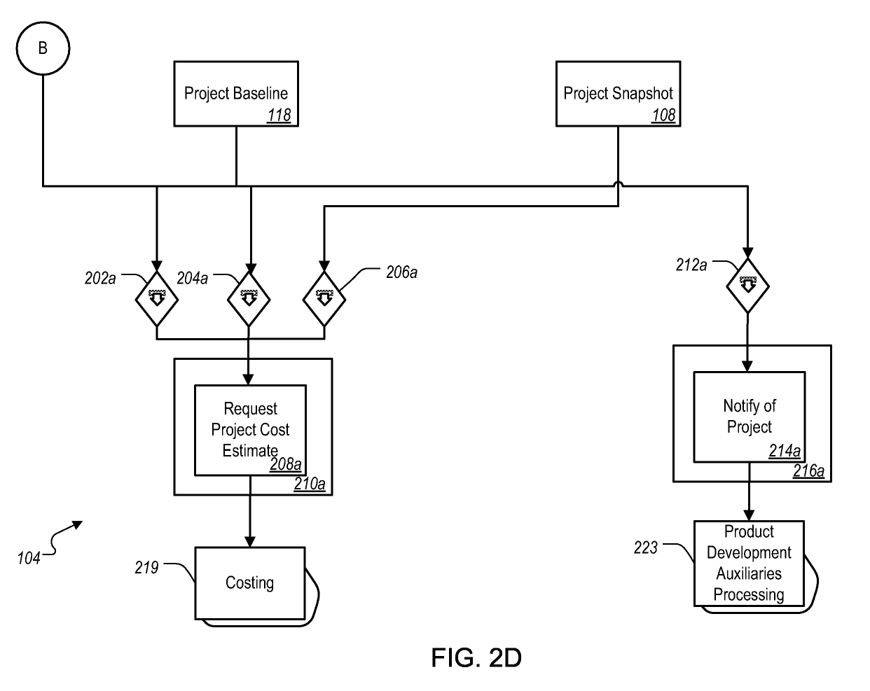

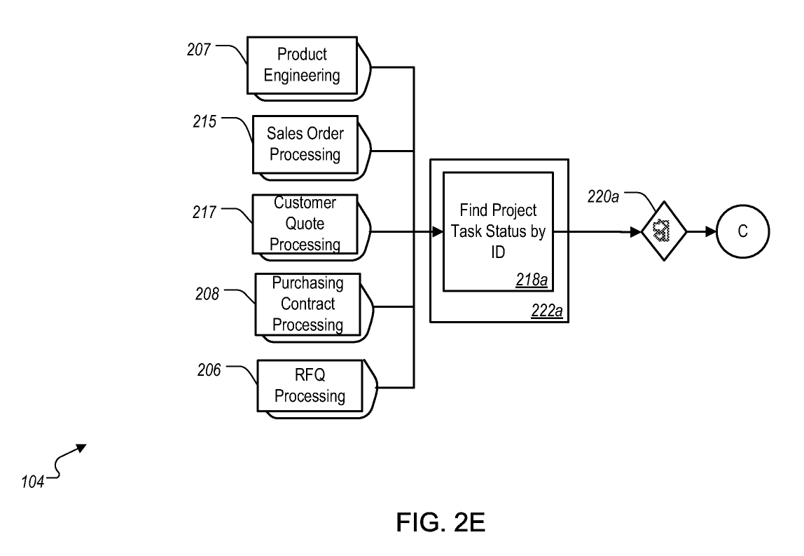

FIGS. 2A, 2B, 2C, 2D, and 2E are block diagrams collectively showing the Project Processing process component 104 (FIG. 1A). For convenience in describing this process component, a number of other process components are shown in the figures; these other process components may not be part of the process component being described. These other process components are a Time and Labor Management process component 202, a Data Migration System process component 204, an RFQ Processing process component 206, a Product Engineering process component 207, a Purchasing Contract Processing process component 208, an Accounting Coding Block Distribution Processing process component 209, an Expense and Reimbursement Management process component 210, a Goods and Service Acknowledgement process component 212, an Inventory Processing process component 214, a Sales Order Processing process component 215, a Supplier Invoice Processing process component 216, a Customer Quote Processing process component 217 an Accounting process component 218, a Costing process component 219, a Purchase Request Processing process component 220, a Purchase Order Processing process component 222, and a Product Development Auxiliaries Processing process component 223. These other process components may be used to represent software external to the process component in describing its interactions with the external software; however, while the external software may be implemented as such process components, this is not required.

As shown in FIG. 2A, a Change Project Based on Employee Time Calendar operation 230 sends a notification to update a project based on confirmations or cancellations of actual work for project tasks using an asynchronous inbound process agent 234 to update the Project business object 110. For example, the operation 230 may send an update of a confirmation of actual work for a project task to update the Project business object 110 if, for example, input is received from the Time and Labor Management process component 202. The Change Project Based on Employee Time Calendar operation 230 is included in a Project Task Confirmation In interface 232.

A Migrate Project operation 236 creates a new project during the data migration process using an asynchronous inbound process agent 240 to update the Project business object 110. For example, the operation 236 may send a request to create a new project during the data migration process to update the Project business object 110 if, for example, input is received from the Data Migration System process component 204. The Migrate Project operation 236 is included in a Project Migration In interface 238.

A Maintain Assignment operation 242 sends a notification to maintain assignments of business objects to project tasks using an asynchronous inbound process agent 246 to update the Project business object 110. The operation 242 may send a notification to maintain assignments of business objects to project tasks to update the Project business object 110 if, for example, input is received from the RFQ Processing process component 206, the Product Engineering process component 207, or the Purchasing Contract Processing process component 208. The Maintain Assignment operation 242 is included in a Project Task Assignment Notification In interface 244.

A Check Project Task Accountability operation 248 checks whether a task can be posted for accounting using a synchronous inbound process agent 252 to update the Project business object 110. For example, the operation 248 may send a request to check whether a task can be posted for accounting to update the Project business object 110 if, for example, input is received from the Accounting Coding Block Distribution Processing process component 209. The Check Project Task Accountability operation 248 is included in a Project Task Accountability In interface 250.

The Project business object 110 may receive updated information from any number of sources and can send the updates into other components to perform further operations. As shown in FIGS. 2A-2E, multiple outbound process agents may receive information from the Project business object 110.

As shown in FIG. 2B, an asynchronous outbound process agent 260 invokes a Notify of Project operation 262. For example, the operation 262 may provide information to the Time and Labor Management process component 202 about tasks and assigned employees in a project. The Notify of Project operation 262 is included in a Project Task Confirmation Out interface 264.

An asynchronous outbound process agent 266 invokes a Notify of Project operation 268. For example, the operation 268 may provide information to the Accounting process component 218 about tasks in a project. The Notify of Project operation 268 is included in a Project Accounting Out interface 270.

A Maintain Project Expense View operation 254 sends a notification to create or cancel a project expense using an asynchronous inbound process agent 258 to update the Project Expense View business object 120. For example, the operation 254 may send a notification to cancel a project expense to update the Project Expense View business object 120 if, for example, input is received from the Expense and Reimbursement Management process component 210, the Goods and Service Acknowledgement process component 212, the Inventory Processing process component 214, and/or the Supplier Invoice Processing process component 216. The Maintain Project Expense View operation 254 is included in a Project Expense Notification In interface 256.

As shown in FIG. 2C, a Change Project Purchase Request based on Purchase Request Notification operation 272 sends a notification to change the project purchase request based on a notification about the creation of a new purchase request and/or a change to an existing purchase request using an asynchronous inbound process agent 276 to update the Project Purchase Request business object 112. For example, the operation 272 may send a notification to change the project purchase request to update the Project Purchase Request business object 112 if, for example, input is received from the Purchase Request Processing process component 220. The Change Project Purchase Request based on Purchase Request Notification operation 272 is included in a Purchasing Notification In interface 274.

A Change Project Purchase Request based on Purchase Request Confirmation operation 278 may send a notification to change the project purchase request based on a confirmation from purchasing about the degree to which a request has been fulfilled using an asynchronous inbound process agent 282 to update the Project Purchase Request business object 112. For example, the operation 278 may send a notification to change the project purchase request to update the Project Purchase Request business object 112 if, for example, input is received from the Purchase Request Processing process component 220. The Change Project Purchase Request based on Purchase Request Confirmation operation 278 is included in a Purchasing In interface 280.

A Change Project Purchase Request based on Purchase Order Notification operation 284 sends a notification to change the project purchase request based on a notification about the creation of a new purchase order and/or a change to an existing purchase order using an asynchronous inbound process agent 288 to update the Project Purchase Request business object 112. For example, the operation 284 may send a notification to change the project purchase request to update the Project Purchase Request business object 112 if, for example, input is received from the Purchase Order Processing process component 222. The Change Project Purchase Request based on Purchase Order Notification operation 284 is included in an Ordering Notification In interface 286.

An asynchronous outbound process agent 290 invokes a Request Purchasing operation 292. For example, the operation 292 may send a request that a purchaser procure services externally for a project to the Purchase Request Processing process component 220. The Request Purchasing operation 292 is included in a Purchasing Out interface 294.

The implementation of the Project Processing process component 104 may be further supported by the Project Snapshot Creation Run business object 114 and the Project Template business object 116 although no operations or process agents involving the business objects 114 and 116 are explicitly shown in FIG. 2C. The Project Snapshot Creation Run business object 114 represents an automated run that creates project snapshots based on selected projects. The Project Template business object 116 represents the structure and/or non-operational data of a project.

As shown in FIG. 2D, the Project Processing process component 104 further includes the Project Snapshot business object 108 and the Project Baseline business object 118. The Project Snapshot business object 108 represents a snapshot of a project that documents the state of a project. The Project Baseline business object 118 represents the internally approved master plan between project sponsors and a project lead.

The Project Baseline business object 118 receives updated information from any number of sources and can send the updates into other components to perform further operations. As shown in FIGS. 2A-2E, multiple outbound process agents may receive information from the Project Baseline business object 118.

As shown in FIG. 2D, one of the asynchronous outbound process agents 202a, 204a, or 206a invokes a Request Project Cost Estimate operation 208a. For example, the operation 208a may provide information to the Costing process component 219 about the creation or change of costing-relevant project elements. The Request Project Cost Estimate operation 208a is included in a Project Costing Out interface 210a.

The Project Snapshot business object 108 receives updated information from any number of sources and can send the updates into other components to perform further operations. As shown in FIGS. 2A-2E, multiple outbound process agents may receive information from the Project Snapshot business object 108.

An asynchronous outbound process agent 212a invokes a Notify of Project operation 214a. For example, the operation 214a may provide information to the Product Development Auxiliaries Processing process component 223 about projects that are relevant for product engineering. The Notify of Project operation 214a is included in a Product Development View of Project Notification Out interface 216a.

As shown in FIG. 2E, a Find Project Task Status by ID (identification) operation 218a sends a notification to retrieve information about the existence of project tasks and their statuses using an synchronous inbound process agent 220a. For example, the operation 218a may send an update to the Project business object 110 if, for example, input is received from the Product Engineering process component 207, the Sales Order Processing process component 215, the Customer Quote Processing process component 217, the Purchasing Contract Processing process component 208, or the RFQ Processing process component 206. The Find Project Task Status by ID operation 218a is included in a Project Task Confirmation In interface 222a.

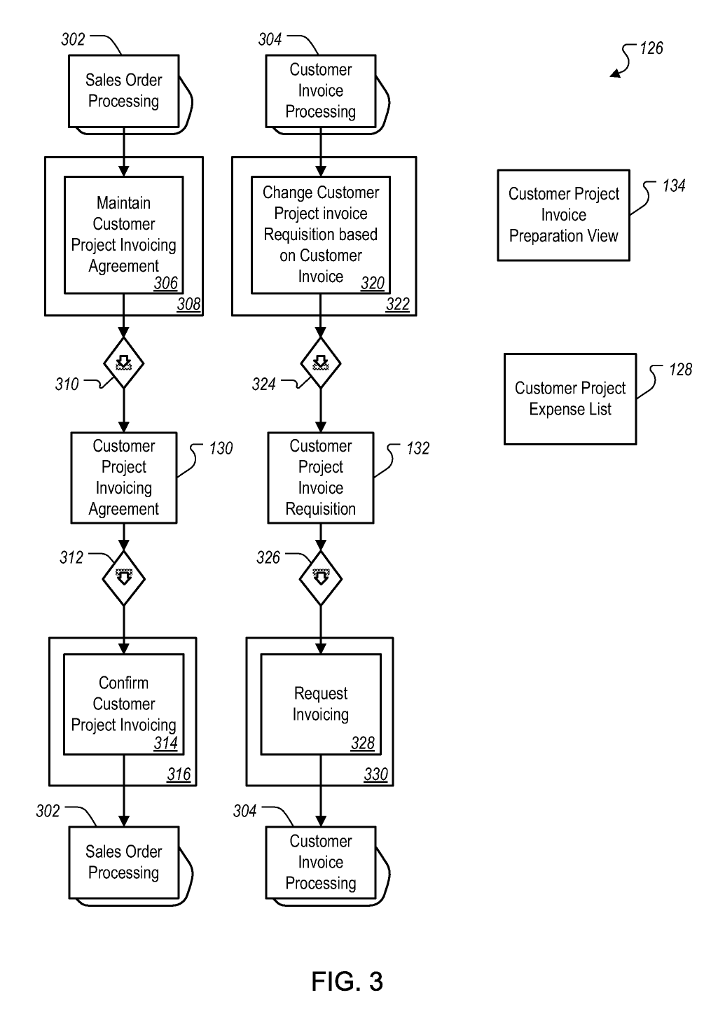

FIG. 3 is a block diagram showing the Customer Project Invoice Preparation process component 126. For convenience in describing this process component, a number of other process components are shown in the figure; these other process components may not be part of the process component being described. These other process components are a Sales Order Processing process component 302, a Customer Invoice Processing process component 304, and the Accounting process component 218. These other process components are used to represent software external to the process component in describing its interactions with the external software; however, while the external software can be implemented as such process components, this is not required.

A Maintain Customer Project Invoicing Agreement operation 306 may send a notification to create, update, or cancel a customer project invoicing agreement using an asynchronous inbound process agent 310 to update the Customer Project Invoicing Agreement business object 130. For example, the operation 306 may send a notification to update a customer project invoicing agreement to update the Customer Project Invoicing Agreement business object 130 if, for example, input is received from the Sales Order Processing process component 302. The Maintain Customer Project Invoicing Agreement operation 306 is included in a Request Customer Project Invoicing In interface 308.

The Customer Project Invoicing Agreement business object 130 may receive updated information and send the update into other components to perform further operations. As shown in FIG. 3, multiple outbound process agents may receive information from the Customer Project Invoicing Agreement business object 130.

An asynchronous outbound process agent 312 may invoke a Confirm Customer Project Invoicing operation 314. For example, the operation 314 may send a confirmation to the Sales Order Processing process component 302 that a customer invoice was created. The Confirm Customer Project Invoicing operation 314 is included in a Request Customer Project Invoicing Out interface 316.

A Change Customer Project Invoice Requisition based on Customer Invoice operation 320 may send a confirmation that a customer invoice based on a customer project invoice requisition was created or canceled using an asynchronous inbound process agent 324 to update the Customer Project Invoicing Requisition business object 132. For example, the operation 320 may send a confirmation that a customer invoice was created to update the Customer Project Invoicing Requisition business object 132 if, for example, input is received from the Customer Invoice Processing process component 304. The Change Customer Project Invoice Requisition based on Customer Invoice operation 320 is included in a Request Invoicing In interface 322.

The Customer Project Invoicing Requisition business object 132 may receive updated information and send the update into other components to perform further operations. As shown in FIG. 3, multiple outbound process agents may receive information from the Customer Project Invoicing Requisition business object 132.

An asynchronous outbound process agent 326 may invoke a Request Invoicing operation 328. For example, the operation 328 may send a send a request to create a customer invoice request or to update a customer invoice request previously created to the Customer Invoice Processing process component 304. The Request Invoicing operation 328 is included in a Request Invoicing Out interface 330.

The Customer Project Expense List business object 128 may receive updated information and send the update into other components to perform further operations. As shown in FIG. 3, multiple outbound process agents may receive information from the Customer Project Expense List business object 128.

An asynchronous outbound process agent 332 may invoke a Notify of Customer Project Expense List operation 334. For example, the operation 334 may send accounting notifications containing accounting-relevant information related to sales order items with assigned customer project tasks to the Accounting process component 218. The Notify of Customer Project Expense List operation 334 is included in Customer Project Expense List Accounting Out interface 336.

The implementation of the Customer Project Invoice Preparation process component 126 may further supported by the Customer Project Invoice Preparation View business object 134, although no operations or process agents involving the business object 134 are explicitly shown in FIG. 3. The Customer Project Invoice Preparation View business object 134 may represent an overview of the data required to prepare an invoice for the items of a sales order relating to a customer project.

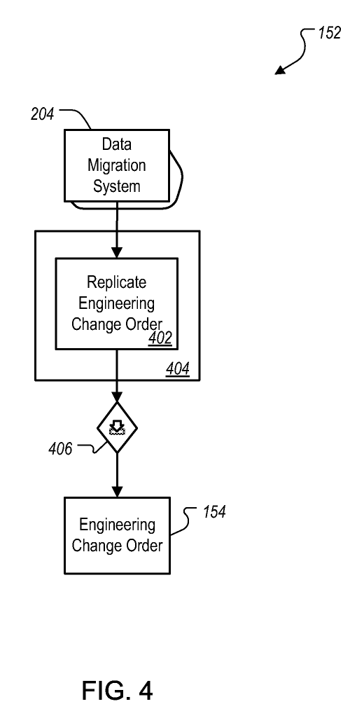

FIG. 4 is a block diagram showing the Engineering Change Processing process component 152 (FIG. 1B). For convenience in describing this process component, an additional process component is shown in the figure; this additional process component may not be part of the process component being described. This other process component is the Data Migration System process component 204. The Data Migration System process component 204 may be used to represent software external to the process component in describing its interactions with the external software; however, while the external software can be implemented as such process component, this is not required.

A Replicate Engineering Change Order operation 402 may send a notification to create, update, or delete an engineering change order using an asynchronous inbound process agent 406 to update the Engineering Change Order business object 154. For example, the operation 402 may send a notification to create an engineering change order to update the Engineering Change Order business object 154 if, for example, input is received from the Data Migration System process component 204. The Replicate Engineering Change Order operation 402 is included in an Engineering Change Order Replication In interface 404.

The Engineering Change Order business object 154 represents a set of instructions to make changes to a number of objects from the areas of engineering or production.

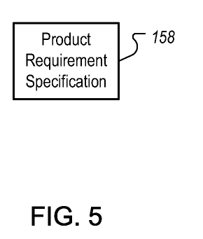

FIG. 5 is a block diagram showing a product requirement specification processing process component 156 (FIG. 1B). The product requirement specification processing process component 156 includes the Product Requirement Specification business object 158. The Product Requirement Specification business object 158 represents a collection of requirements for a product used in a specific business context, for example, in a prototype, development project, or sales order. The business object 158 can also contain the corresponding specifications for fulfilling these requirements.

The subject matter described in this specification and all of the functional operations described in this specification can be implemented in digital electronic circuitry, or in computer software, firmware, or hardware, including the structural means disclosed in this specification and structural equivalents thereof, or in combinations of them. The subject matter described in this specification can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described in this specification can be implemented in a computing system that includes a back-end component (e.g., a data server), a middleware component (e.g., an application server), or a front-end component (e.g., a client computer having a graphical user interface or a Web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as an exemplification of preferred embodiments of the invention. Certain features that are described in this specification in the context of separate embodiments, may also be provided in combination in a single embodiment. Conversely, various features that are described in the context of a single embodiment may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter has been described in terms of particular variations, but other variations can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A computer readable medium including program code for providing message-based services using a service-oriented methodology for implementing an instance of a deployment unit, the medium comprising:
program code for storing an instance of a project management deployment unit for managing simple, short-term measures and complex projects, where the project management deployment unit defines the limits of an application-defined transaction for managing simple, short-term measures and complex projects by a set of actions that have atomicity, consistency, isolation, and durability in a database, and where the actions associated with the application-defined transaction are performed by one or more process components contained in the project management deployment unit, wherein each process component comprises a software package realizing a business process and exposing its functionality as one or more service operations, wherein the project management deployment unit comprises:
a project processing process component, wherein the project processing process component implements the following service operations:
a check project task accountability operation that checks whether a task is posted for accounting;
a change project based on employee time calendar operation that updates a project based on confirmations or cancellations of actual work for project tasks;
a find project task status by identification operation that retrieves information about the existence of project tasks and their statuses;
a notify of project operation that provides information to time and labor management about tasks and assigned employees in a project;
a migrate project operation that creates a new project during the data migration process;
a change project purchase request operation based on purchase request notification that changes the project purchase request based on a notification about the creation of a new purchase request or a change to an existing purchase request;
a change project purchase request operation based on purchase request confirmation that changes the project purchase request based on a confirmation from purchasing about the degree to which a request has been fulfilled;
a change project purchase request operation based on purchase order notification that changes the project purchase request based on a notification about the creation of a new purchase order or a change to an existing purchase order;
a notify of project operation that provides information to accounting about tasks in a project;
a request project cost estimate operation that notifies costing about the creation or change of costing-relevant project elements;
a maintain project expense view operation that creates or cancels a project expense;
a maintain assignment operation that maintains assignments of business objects to project tasks;
a notify of project operation that notifies product development about projects that are relevant for product engineering; and
a request purchasing operation that requests that a purchaser procure services externally for a project; and
a customer project invoice preparation process component, wherein the customer project invoice preparation process component implements the following service operations:
a change customer project invoice requisition based on customer invoice operation that confirms that a customer invoice based on a customer project invoice requisition was created or canceled;
a confirm customer project invoicing operation that confirms to a sales order that a customer invoice was created;
a maintain customer project invoicing agreement operation that creates, updates, or cancels a customer project invoicing agreement;
a request invoicing operation that requests the creation of a customer invoice request or to update a customer invoice request previously created; and
an executive initiative management process component;
wherein the process components of the project management deployment unit are packaged together to be deployed on a single computer system;
program code for executing the application-defined transaction for managing simple, short-term measures and complex projects; and
program code for presenting data associated with the executed application-defined transaction for managing simple, short-term measures and complex projects to a graphical user interface.

2. The medium of claim 1, wherein the project processing process component comprises a project request business object, project business object, a project baseline business object, a project purchase request business object, a project snapshot creation run business object, a project snapshot business object, a project expense view business object, a project template business object, and a project processing view of customer transaction document business object.

3. The medium of claim 1, wherein the customer project invoice preparation process component comprises a customer project invoice preparation view business object, a customer project expense list business object, a customer project invoice requisition business object and, a customer project invoicing agreement business object.

4. The medium of claim 1, wherein the executive initiative management process component comprises an executive initiative business object.

5. The medium of claim 1, wherein the services operations associated with the project processing process component are grouped into service interfaces, the service interfaces comprising:
an ordering notification in interface that includes the change project purchase request based on purchase order notification operation;
a product development view of project notification out interface that includes the notify of project operation;
a project accounting out interface that includes the notify of project operation;
a project costing out interface that includes the request project cost estimate operation;
a project expense notification in interface that includes the maintain project expense view operation;
a project migration in interface that includes the migrate project operation;
a project task accountability in interface that includes the check project task accountability operation;
a project task assignment notification in interface that includes the maintain assignment operation;
a project task confirmation in interface that includes the change project based on employee time calendar operation and the find project task status by identification operation;
a project task confirmation out interface that includes the notify of project operation;
a purchasing in interface that includes the change project purchase request based on purchase request confirmation operation;
a purchasing notification in interface that includes the change project purchase request based on purchase request notification operation; and
a purchasing out interface that includes the request purchasing operation.

6. The medium of claim 1, wherein the services operations associated with the customer project invoice preparation process component are grouped into service interfaces, the service interfaces comprising:
a request customer project invoicing in interface that includes the maintain customer project invoicing agreement operation;
a request customer project invoicing out interface that includes the confirm customer project invoicing operation;
a request invoicing in interface that includes the change customer project invoice requisition based on customer invoice; and
a request invoicing out interface that includes the request invoicing operation.

7. The medium of claim 1, wherein the single computer system comprises a single physical hardware platform.
